(19) United States
(12) Patent Application Publication
(10) Pub. No.: US 2026/0216547 A1
(43) Pub. Date: Jul. 30, 2026

(54) BATTERY FIRE EXTINGUISHING MEMBER

(71) Applicant: Youngku SHIN, Gwangjusi, Gyeonggi-do (KR)

(72) Inventor: Youngku SHIN, Gwangjusi, Gyeonggi-do (KR)

(21) Appl. No.: 19/147,143

(22) PCT Filed: Dec. 12, 2023
(86) PCT No.: PCT/KR2023/020458

§ 371 Date: Jul. 10, 2025

(30) Foreign Application Priority Data
Jan. 16, 2023 (KR) 10-2023-0006074

(51) Int. Cl. A62D 1/00; A62C 3/16; C09D 5/18; C09D 7/61; H01M 50/24

(52) U.S. Cl. CPC A62D 1/0014; A62C 3/16; C09D 5/18; C09D 7/61; H01M 50/24

(57) ABSTRACT

The present invention provides a battery fire extinguishing material and member in which glass powder and a binder are used so that ignition and thermal runaway of a battery can be suppressed at an early stage. The present invention relates to a battery fire extinguishing member that is molded in a plate shape in order to be installed on top of a battery, the member comprising glass powder and a binder for binding the glass powder. Accordingly, the present invention has the effect of preventing the spread of fire in advance by cutting off oxygen by using a melting endothermic function of the glass powder and a film forming function of molten glass to control ignition and high-temperature thermal runaway of the battery.

### TECHNICAL FIELD

The present invention relates to a battery fire extinguishing member, and more particularly, to a battery fire extinguishing material and member and a method of extinguishing a fire using same to extinguish a fire caused by a battery ignition so as to prevent the fire from burning down a vehicle or spreading due to the fire of the battery fire.

### BACKGROUND ART

Batteries are used in various application products such as electric vehicles and kickboards, and battery fires occur during charging or driving, or due to various reasons. Accordingly, it frequently leads to vehicle burnouts, house fires, and even loss of life.

Particularly, unlike general fires, a thermal runaway phenomenon occurs when a lithium battery catches fire. Regarding the thermal runaway phenomenon in a viewpoint of a battery cell, when the battery fails to manage heat properly and remains at a predetermined temperature or higher, electrolyte in the battery cell may gasify to increase a pressure inside the battery cell. A flammable electrolyte material may vaporize and spout, the increased pressure inside the battery may increase the possibility of damage to a separator, and ignition may occur internally due to a short circuit or a flammable gaseous substance, resulting in heating of adjacent battery cells. Thus, the fire gradually spreads and eventually causes a fire in the entire battery.

When the battery fire occurs, the fire may further spread when water is used to suppress the fire since lithium ions easily react with water, and accordingly, the battery may not be extinguished smoothly until the lithium electrodes themselves are completely exhausted.

There have been various disclosures of fire-extinguishing methods upon battery ignition or devices for blocking the battery ignition at early stages, however, most methods and devices have difficulties in effectively preventing the ignition and thermal runaway of batteries. Accordingly, there is an urgent need in the art for new approaches to effectively prevent the ignition and thermal runaway of batteries.

### DISCLOSURE

### Technical Problem

An object of the present invention is to provide a battery fire extinguishing material and member to prevent battery ignition and thermal runaway at an early stage.

### Technical Solution

According to one aspect of the present invention to solve the technical problem, a battery fire extinguishing member formed in a plate shape to be installed on the top of the battery includes glass powder and a binder for binding the glass powder.

According to one embodiment, the glass powder may be a material having a melting temperature in a range of 480° C. to 800° C.

According to one embodiment, the glass powder may be formed by selectively mixing at least one of PbO, CoO, and ZnO into a mixture of SiO₂, B₂O₃, and R₂O.

A method of manufacturing a battery fire extinguishing member according to another aspect of the invention includes the steps of: preparing glass powder; preparing a glass mixture by mixing the glass powder with water; and coating an upper surface of a battery by spraying the glass mixture onto the upper surface of the battery.

### Advantageous Effects

The present invention provides a battery fire extinguishing material and member using glass powder and binders to prevent battery ignition and thermal runaway at an early stage, so that total loss of a vehicle or resulting casualties can be prevented.

### DESCRIPTION OF DRAWINGS

FIG. 1 is a view showing a simplified example of applying a battery fire extinguishing member 10 of the present invention using glass powder and a binder to an upper surface of a battery 1.

FIG. 2 is a table showing melting temperatures of various materials of the glass powder used in the battery fire extinguishing member 10 of the present invention.

### BEST MODE

### Mode for Invention

Hereinafter, the exemplary embodiments of the present invention will be described with reference to the accompanying drawings. It will be noted that the accompanying drawings and the embodiments described with reference thereto have been simplified and exemplified to aid in the understanding of the present invention by those skilled in the art to which the present invention pertains.

First, in regard to glass powder used in the present invention, glass used as a material for coating ceramics or enamel tiles is generally prepared by making various types of fine powders such as soda-lime glass, borate glass and lead glass and adding inorganic pigments thereto.

The features of the glass powder to be noted in the present invention are an endothermic reaction for melting glass and a film-forming function of molten glass. In other words, when a battery catches fire, glass powder absorbs rushing heat and melts to form a film on the battery and block oxygen, resulting in extinguishing the fire.

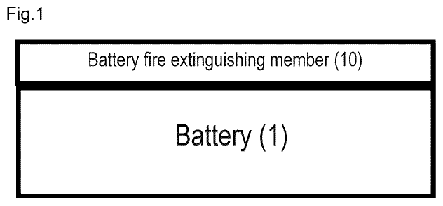

FIG. 1 is a view showing a simplified example of applying a battery fire extinguishing member 10 of the present invention using glass powder and a binder to an upper surface of a battery 1. As shown in FIG. 1, the battery fire extinguishing member 10 of the present invention is installed on a top of the battery 1 and has a plate shape.

The battery fire extinguishing member 10 of the present invention includes glass powder and a binder for binding the glass powder.

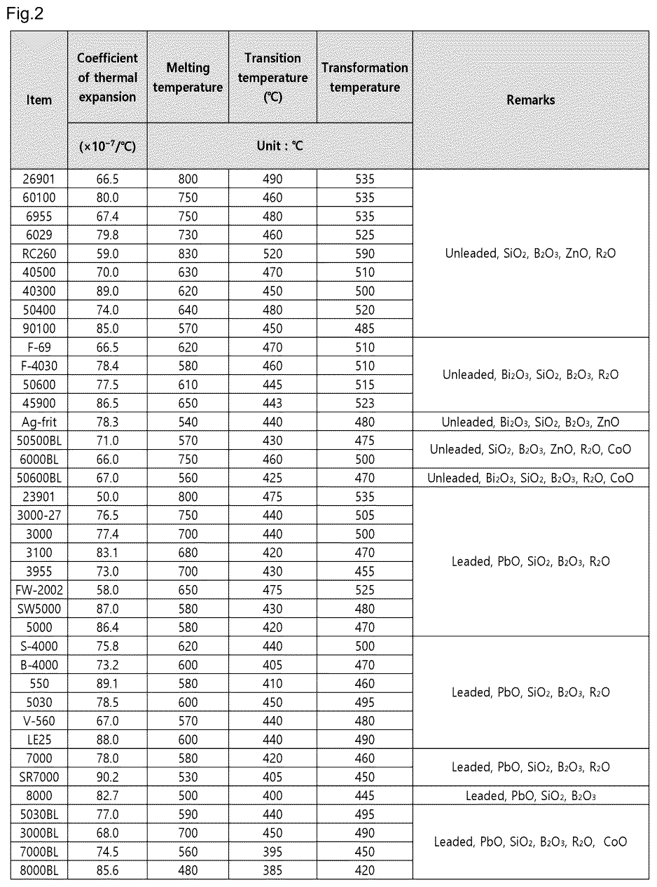

Examples of the glass powder are shown in a table of FIG. 2. It is confirmed that a thermal runaway temperature upon battery ignition is a high temperature of several hundred degrees Celsius to 1000° C. or more, and accordingly, the glass powder is desirably formed of a material having a melting temperature in the range of 480° C. to 800° C. as a whole.

As shown in the table of FIG. 2, glass powder of a lead-containing (leaded) mixture generally has a lower melting temperature compared to a lead-free (unleaded) mixture. For example, the glass powder may be suitably used by selectively mixing at least one of PbO, CoO, and ZnO into a mixture of SiO₂, B₂O₃, and R₂O. In the above R₂O, R represents an alkyl group.

Since the battery fire occurs at an upper portion of a battery as a whole, the battery fire extinguishing member according to the present invention is installed on a top of the battery, so that the spread of fire upon battery ignition and thermal runaway can be prevented by blocking oxygen through melting of glass powder. Alternatively, it may also be applied to sides of the battery and a bottom of the battery.

The battery fire extinguishing material may be applied to the battery after being manufactured in a thin film or plate shape in advance, however, may also be manufactured in-situ by preparing glass powder, mixing the prepared glass powder with water to prepare a glass mixture solution, and spraying the glass mixture solution onto a top surface of the battery to coat the top surface of the battery to have a thin or appropriate thickness.

In the above manner, the melting heat absorption function of glass powder and the film forming function of molten glass are used by using the battery fire extinguishing material or member of the present invention, so as to effectively control ignition and thermal runaway of the battery to block oxygen, thereby preventing the spread of fire.

1. A battery fire extinguishing member molded in a plate shape to be installed on top of a battery, the battery fire extinguishing member comprising:
glass powder; and
a binder for binding the glass powder.

2. The battery fire extinguishing member of claim 1, wherein the glass powder includes a material having a melting temperature in a range of 480° C. to 800° C.

3. The battery fire extinguishing member of claim 2, wherein the glass powder is formed by selectively mixing at least one of PbO, CoO, and ZnO into a mixture of SiO₂, B₂O₃, and R₂O.

4. A method of manufacturing a battery fire extinguishing member, the method comprising:
preparing glass powder;
preparing a glass mixture by mixing the glass powder with water; and
coating an upper surface of a battery by spraying the glass mixture onto the upper surface of the battery.
